(19) United States
(12) Patent Application Publication
(10) Pub. No.: US 2017/0239933 A1
(43) Pub. Date: Aug. 24, 2017

(54) FLEXIBLE CELL ELEMENT AND METHOD FOR PRODUCTION OF A FLEXIBLE CELL ELEMENT UNIT FROM THIS CELL ELEMENTS BY ADDITIVE MANUFACTURING TECHNIQUES

(71) Applicant: MATERIALISE N.V., Leuven (BE)

(72) Inventors: Phillippe SCHIETTECATTE, Boortmeerbeek (BE); Roman PLAGHKI, Leuven (BE); Dries VANDECRUYS, Leuven (BE); Jolien RASSCHAERT, Leuven (BE); Willem Jan VERLEYSEN, Kessel-Lo (BE)

(73) Assignees: MATERIALISE N.V., Leuven (BE); MATERIALISE N.V., Leuven (BE)

(21) Appl. No.: 15/506,175

(22) PCT Filed: Aug. 21, 2015
(86) PCT No.: PCT/EP2015/069236

§ 371 Date: Feb. 23, 2017

Related U.S. Application Data
(60) Provisional application No. 62/041,482, filed on Aug. 25, 2014.

(51) Int. Cl. B33Y 80/00; B33Y 10/00; A41D 31/00; A41D 13/00; A41D 1/00; B33Y 50/02; B29C 67/00

(52) U.S. Cl. CPC B33Y 80/00; B33Y 50/02; B33Y 10/00; B29C 67/0088; A41D 13/0005; A41D 1/00; A41D 31/0011; A41D 31/0005; B29L 2031/48

(57) ABSTRACT

A flexible unit cell is disclosed. The flexible unit cell is a single unit that can be repeated and interconnected to create a flexible design such as a covering for an object or person. The flexible unit includes a rigid portion and a flexible connection portion. Flexible units connect via the flexible connection portion to form a flexible design that can move and flex based on the connection of the flexible connection portions between flexible units. Further, the rigid portions of the flexible units may not be connected, allow such movement. The flexible unit is designed such that a flexible design made using such flexible units maintains a degree of rigidity so it can keep a shape of a surface of an object, but also maintains enough flexibility to conform to the surface even if the object bends or moves. Further disclosed are processes for manufacturing such flexible unit cells.

### CROSS-REFERENCE TO RELATED APPLICATIONS

This application claims the benefit of U.S. Provisional Application No. 62/041,482, filed Aug. 25, 2014, the contents of which are incorporated herein by reference in their entirety.

### BACKGROUND OF THE INVENTION

Field of the Invention

This application relates to flexible unit cells. In particular, this application relates to the design and use of flexible unit cells which can be used to create durable and flexible 3D printed materials, such as for use in textiles or other flexible covering applications.

Description of the Related Technology

Traditional designs and materials are not well adapted to be used in a sufficiently flexible material that is also able to maintain a particular shape. For example, there are cases in which it is desirable to create a covering or skin for an object or person that is rigid to some degree to provide some protection for the object or person, but also has flexibility to allow the covering to adapt to changes in shape or movement of the object or person.

One such example may be a chest covering used as a protective covering for a person. It may be desirable to efficiently create a chest covering for a person that is rigid to protect the person, but also flexible to allow freedom of movement of the person while wearing the chest covering. Current materials are either too flexible (e.g., cloth-like and flimsy so as to not maintain a shape) or too rigid (e.g., hardened materials that conform to a particular shape but do not bend easily, thus restricting movement).

Further, since each object and person is different, it may be desirable to have design processes and systems that can efficiently create customized materials for each different object and person.

Accordingly, there is a need for materials that are designed to be flexible enough to conform to different object, but also rigid in certain degrees to provide some protection of the object.

### SUMMARY

In one embodiment, a flexible unit cell is disclosed. The flexible unit cell comprises a rigid portion configured to interact with at least one additional flexible unit cell so as to limit relative movement between the flexible unit cell and the at least one additional flexible unit cell. The flexible unit cell further comprises a flexible connection portion configured to connect with the at least one additional flexible unit cell so as to allow relative movement between the flexible unit cell and the at least one additional flexible unit cell.

In another embodiment, a method for designing a flexible design comprising a plurality of flexible unit cells is disclosed. Each flexible unit cell comprises a rigid portion configured to interact with at least one additional flexible unit cell so as to limit relative movement between the flexible unit cell and the at least one additional flexible unit cell. Each flexible unit cell further comprises a flexible connection portion configured to connect with the at least one additional flexible unit cell so as to allow relative movement between the flexible unit cell and the at least one additional flexible unit cell. The method comprises obtaining a representation of a surface of an object. The method further comprises matching one or more regions of the surface with at least one type of flexible unit cell based on at least a curvature or flexibility requirement of the one or more regions. The method further comprises pre-shaping the flexible design to the surface of the object.

### BRIEF DESCRIPTION OF THE DRAWINGS

FIG. 1 is a top, perspective view of a flexible design comprising flexible unit cells according to one or more embodiments disclosed herein.

FIG. 2 is a top, perspective view of the flexible design comprising flexible unit cells from FIG. 1.

FIG. 3 is a top, perspective view of the flexible design comprising flexible unit cells from FIG. 1.

FIG. 4 is a cutaway view of the flexible design comprising flexible unit cells from FIG. 1.

FIG. 5 is a cutaway view of the flexible design comprising flexible unit cells from FIG. 1.

FIG. 6 is a side view of the flexible design comprising the flexible unit cells from FIG. 1.

FIG. 7 is a side view of another embodiment of a flexible design comprising flexible unit cells.

FIG. 8 is a side view of another embodiment of a flexible design comprising flexible unit cells.

FIG. 9 is an example of a flexible design comprising a body suit comprising flexible unit cells.

FIG. 10 is a flowchart illustrating one example of a process for designing and manufacturing one or more embodiments of the flexible designs disclosed herein.

FIG. 11 illustrates one example of a system for designing and manufacturing one or more embodiments of the flexible designs disclosed herein.

FIG. 12 illustrates a more detailed view of a computer of the system of FIG. 11.

FIG. 13 illustrates a general process for manufacturing one or more embodiments of the flexible designs disclosed herein using an additive manufacturing apparatus of FIG. 11.

### DETAILED DESCRIPTION OF CERTAIN INVENTIVE EMBODIMENTS

The inventors have recognized a need for a design for a material that can be easily manufactured, customized, and provides both flexibility and rigidity. In order to meet this need, the inventors have designed a flexible unit cell design that can be repeated and interconnected to create a flexible design (material/overlay/skin/covering). Further, in some embodiments, the flexible unit cells are designed to be manufactured using additive manufacturing techniques (e.g., 3D printing) collectively as a single form design (i.e., one continuous part) to allow for ease of manufacturing and customization as further discussed herein.

In some embodiments, a flexible unit cell can be made in a variety of different shapes and sizes. For example, a flexible unit cell have may have a geometric shape (e.g., triangle, square, pentagon, etc.) of a given size. Further, each flexible unit cell may comprise at least one rigid portion that maintains the general shape of the flexible unit cell, and at least one flexible connection portion that allows the flexible unit cell to connect to other flexible unit cells. In some embodiments, the flexible unit cell may have multiple flexible connection portions, each flexible connection portion being configured to connect to a flexible connection portion of another flexible unit cell, such that a single flexible unit cell may connect to multiple other flexible unit cells.

In embodiments where the flexible unit cells have a geometric shape, the flexible unit cells may accordingly have the same number of sides as the geometric shape (e.g., 3 sides for a triangle, 4 sides for a square, etc.). In some embodiments, each flexible unit cell may be configured to connect or interconnect with another flexible unit cell at each such side or edge of the flexible unit cell. The flexible unit cells may be configured to connect to other flexible unit cells of the same and/or different configuration (e.g., shape, material, size).

In some embodiments, the flexible unit cells connect to each other or interconnect through their flexible connection portions, while the rigid portion of one flexible unit cell is not directly connected to the rigid portion of another flexible unit cell. This allows the rigid portions of the flexible unit cells to move relative to or with respect to one another, while still maintaining a degree of rigidity.

In some embodiments, the rigid portion of the flexible unit cell may comprise one or more surfaces or components that alone or combined are in the general shape (e.g., triangle, square, pentagon, etc.) of the flexible unit cell. Each surface or component of the rigid portion may have the same or different thicknesses and be made of the same or different materials. Each surface or component may be sufficiently thick enough and of a material that it is rigid and not flexible under a reasonable amount of force. For example, the rigid portion may comprise a plastic of a sufficient thickness. It will be understood by one of skill in the art that the desired rigidity can be achieved by varying the material and/or thickness of the rigid portion as needed when designing the flexible unit cell.

The rigid portion of each flexible unit cell may be configured to act as a stop to restrict the movement of interconnected flexible unit cells with respect to each other. For example, as the interconnected flexible unit cells move with respect to one another in a given direction, the rigid portion of one flexible unit cell may contact the rigid portion of another flexible unit cell and therefore stop or inhibit movement in that direction between the flexible unit cells. The rigid portion of each flexible unit cell may comprise multiple such contact areas that interact with contact areas of another flexible unit cell to restrict movement in a given direction. Accordingly, a flexible design made of multiple flexible unit cells may be configured to move/flex in certain directions at differing areas of a flexible design depending on the design and interaction of contact areas between interconnected flexible unit cells in that area.

In some embodiments, the flexible connection portion of the flexible unit cell may comprise a flexible mechanism. For example, the flexible connection portion may comprise a flexible hinge, such as a leaf spring. In some embodiments, the flexible connection portion may be made of the same material as the rigid portion. In other embodiments, the flexible connection portion may be made of a different material than the rigid portion. It will be understood by one of skill in the art that the desired flexibility can be achieved by varying the material, thickness, shape, and/or design of the flexible connection portion as needed when designing the flexible unit cell.

In some embodiments, the flexible connection portion may provide flexibility in any number of directions and have a generally free range of motion. In some embodiments, the shape and/or orientation of the flexible connection portion may be designed to limit movement or flexibility in one or more directions. For example, the flexible connection portion may comprise a vertical leaf spring that allows for movement of interconnected flexible unit cells in a horizontal direction with respect to each other, but limits movement of interconnected flexible unit cells in a vertical direction with respect to each other. In another example, the flexible connection portion may comprise a horizontal leaf spring that allows for movement of interconnected flexible unit cells in a vertical direction with respect to each other, but limits movement of interconnected flexible unit cells in a horizontal direction with respect to each other.

In some embodiments, as described above, a flexible unit cell may comprise multiple flexible connection portions. In such embodiments, each flexible connection portion of the flexible unit cell may be of the same type (e.g., horizontal leaf spring) or the flexible connection portions may be of two or more different types. Accordingly, a flexible design made of multiple flexible unit cells may be configured to move/flex to certain degrees and in certain directions at differing areas of the flexible design depending on the type of flexible connection portions used to interconnect flexible unit cells in that area.

The shape and/or size of the flexible unit cell, including the shape and/or size of the rigid portion, may also be adjusted to configure the degree and direction of movement/flex between interconnected flexible unit cells as desired. For example, in a flexible design made of multiple flexible unit cells, the number of interconnections between flexible unit cells in a given area may affect the degrees of freedom in that area of the flexible design as the flexible design can only flex in the areas where there is an interconnection via a flexible connection portion. Therefore, an area with several smaller flexible unit cells may include a greater number of interconnections than if the same area had larger flexible unit cells. Therefore, using smaller flexible unit cells may allow for a greater degree of flexibility of the overall design as a greater number of smaller flexible unit cells will fit in a given area than would larger flexible unit cells. For example, if a given area has, for example, N number of flexible unit cells, each allowing for a degree of flexibility at an angle 0 between each flexible unit cell, the overall flexibility of the design is N*θ. If N is decreased, the overall flexibility is decreased. If N is increased, the overall flexibility is increased.

Further, the shape of the flexible unit cells used in a particular area of a flexible design may affect the direction of movement. Depending on the shape of the flexible unit cells, the flexible connection portions may each be separated from each other by the same or a different angle around all 360 degrees of the flexible unit cells. Since interconnected flexible unit cells only move with respect to each other at flexible connection portions, the placement of the flexible connection portions around the flexible unit cells, will, as understood by one of skill in the art, changed the way in which the overall flexible design can move.

Detailed examples of the inventive embodiments described above are set forth below.

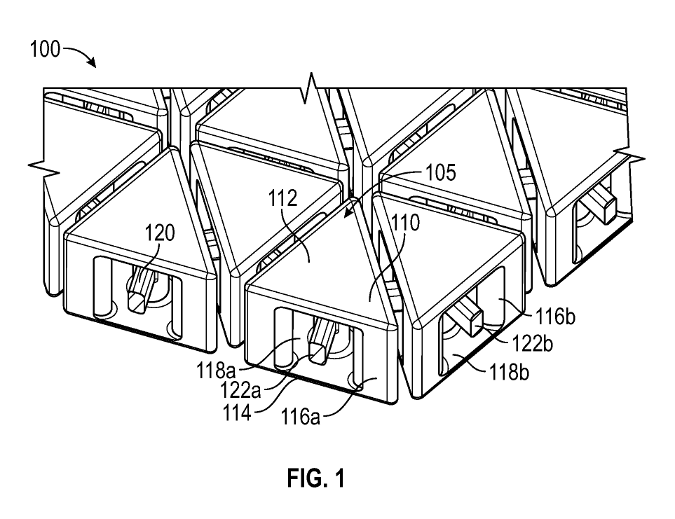

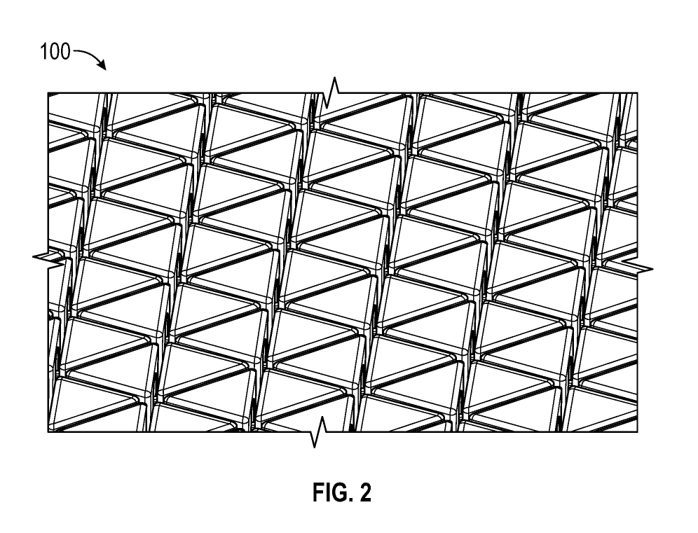

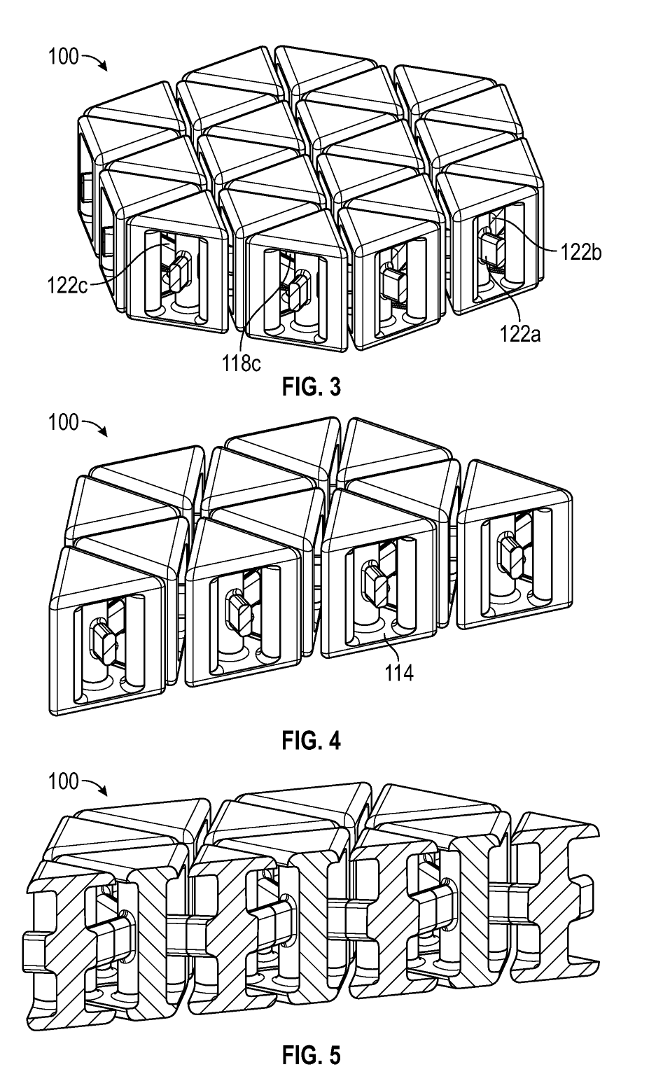

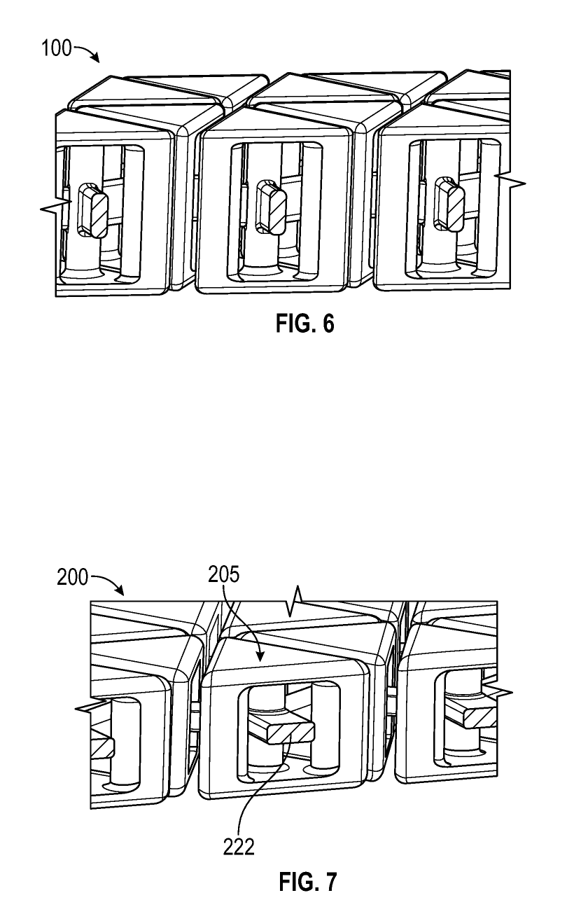

Turning now to FIGS. 1-6, an example of a flexible design 100 is provided. The flexible design 100 includes a plurality of flexible unit cells 105. As shown, the flexible unit cells 105, in this example, are in the shape of triangles, though other shapes are possible as discussed above. The flexible unit cell 105 includes a rigid portion 110. The rigid portion 110 comprises a top surface 112 and a bottom surface 114, each of which is in the same substantial shape (in the example shown, a triangle) as the flexible unit cell 105. The rigid portion 110 further comprises side portions 116a, 116b, and 116c on each side of the flexible unit cell 105. Each side portion 116a, 116b, and 116c includes an opening 118a, 118b, and 118c respectively. The opening is shown as a rectangular shape, though in some embodiments, other sizes and shapes of opening may be used. Further, each opening 118a, 118b, and 118c may be of the same size and shape, or of different sizes and/or shapes. The rigid portion 110 further comprises a central portion 120. The top surface 112 and bottom surface 114 are connected, as shown, by the side portions 116 and the central portion 120.

The flexible unit cell 105 further includes flexible connection portions 122a, 122b, and 122c. As shown, the flexible connection portions 122a, 122b, and 122c comprise vertical leaf springs. The flexible connection portions 122a, 122b, and 122c are connected to the central portion 120 of the rigid portion 110 of the flexible unit cell 105. Further, as shown, at least one of the flexible connection portions 122a, 122b, and 122c of one flexible unit cell 105 is connected to at least one of the flexible connection portions 122a, 122b, and 122c of another flexible unit cell 105.

Further, the flexible design 100, as shown, has been formed as a single form design (i.e., one continuous part). Therefore, any “connections” referred to between components of the flexible design 100 including flexible unit cells 105 are for ease of understanding, and not meant to imply connections that are made after manufacture of individual flexible unit cells 105. However, in some other embodiments, the connections between components of the flexible design 100 including flexible unit cells 105 may be connections that allow individual flexible unit cells 105 to be interconnected after manufacture, either permanently or detachably.

In the embodiment shown, the flexible connection portions 122a, 122b, and 122c comprise vertical leaf springs, thus the flexible unit cells 105 are limited from moving in the horizontal direction to a greater degree than they are from moving in the vertical direction. In addition, the various components of the rigid portion 110 restrict movement in different directions. For example, movement in one vertical direction is limited as the top surface 112 and/or side portion 116 of one flexible unit cell 105 when moved vertically, will contact the top surface 112 and/or side portion 116 of an adjacent flexible unit cell 105 after a certain degree of movement, thus restricting the movement. Similarly, movement in another vertical direction is limited as the bottom surface 114 and/or side portion 116 of one flexible unit cell 105 when moved vertically, will contact the bottom surface 114 and/or side portion 116 of an adjacent flexible unit cell 105 after a certain degree of movement, thus restricting the movement. Additionally, movement in the horizontal direction is limited as the side portion 116 of one flexible unit cell 105 when moved horizontally, will contact the side portion 116 of an adjacent flexible unit cell 105 after a certain degree of movement, thus restricting the movement.

FIG. 7 shows another example of a flexible design 200 that is similar to the flexible design 100. The flexible design 200 includes flexible unit cells 205 that are similar to the flexible unit cell 105 in form and function, except the flexible unit cells 205 have flexible connection portions 222 that comprise horizontal leaf springs.

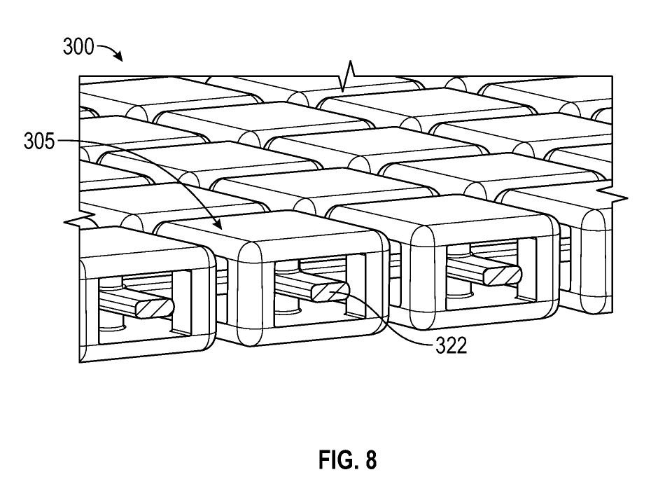

FIG. 8 shows another example of a flexible design 300 that is similar to the flexible design 100. The flexible design 300 includes flexible unit cells 305 that are similar to the flexible unit cell 105 in form and function, except the flexible unit cells 305 have flexible connection portions 322 that comprise horizontal leaf springs, and the flexible unit cells 305 are square shaped.

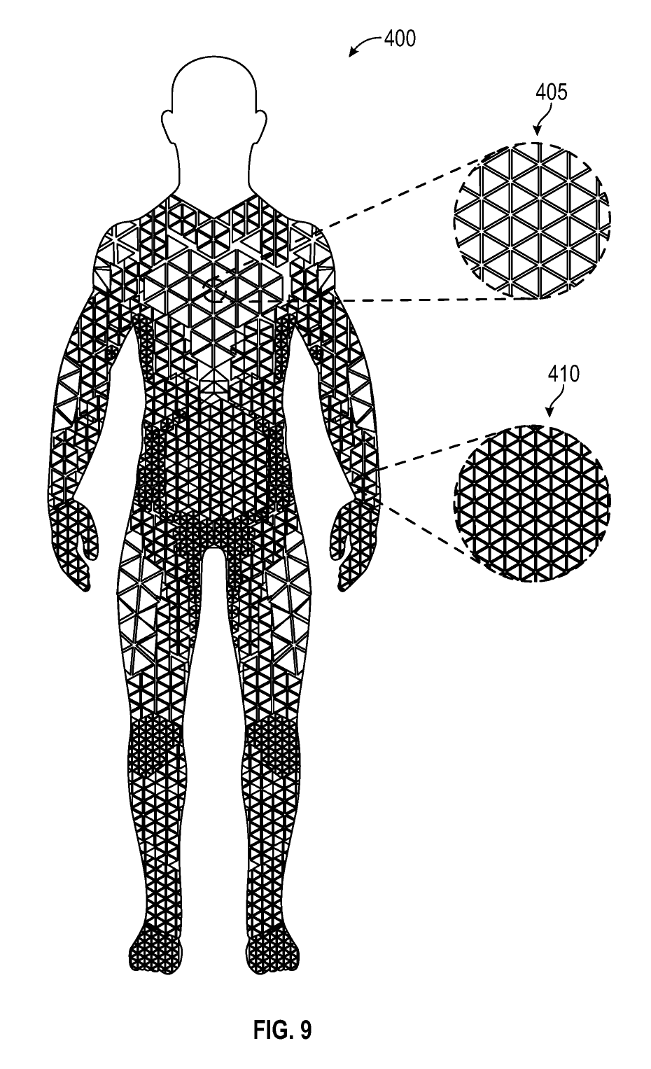

FIG. 9 shows a further example of a flexible design 400. The flexible design 400 comprises a body suit that is made up of flexible unit cells, such as those described herein. As shown, different parts of the flexible design 400 are made up of or comprise different flexible unit cells. For example in a region 405 near the chest, the flexible design 400 is made up of triangle shaped flexible unit cells that are larger in size than flexible unit cells in other regions of the flexible design 400, such as a region 410 near the wrist. As discussed above, a region with larger sized flexible unit cells may not have as great of a degree of flexibility as a region with smaller sized flexible unit cells. For example, the chest of a person does not need to move as much as the wrist of a person. Accordingly, the flexible design 400 uses smaller flexible unit cells in the wrist region 410 to accommodate the movement and flexibility needed in that area, while larger flexible unit cells are used in the chest region 405 as a lesser degree of movement and flexibility is needed. As will be understood be one of skill in the art, the flexible connection portions of the flexible unit cells of different regions of the flexible design 400 can be designed as appropriate to allow movement in the desired directions in that region as discussed above.

As discussed above, the flexible design and/or flexible unit cells discussed herein may be manufactured using additive manufacturing techniques. Accordingly, the flexible unit cells may be designed to lend itself to manufacturing using such techniques. For example, as shown in some of the embodiments of the flexible unit cells described herein, including that of FIG. 1, the flexible design is designed to be manufactured as a single continuous design, meaning all parts are integrated together. Further, as shown, in some embodiments the flexible connection portions 122a, 122b, and 122c are internal to the flexible unit cell 105, with most portions of the rigid portion 110 being external to the flexible unit cell 105. The internal space of the flexible unit cell 105 may be made of sufficient size and space so that excess material (e.g., powder) may easily be removed from openings 118a, 118b, and/or 118c after the flexible unit cell 105 is built using the additive manufacturing techniques.

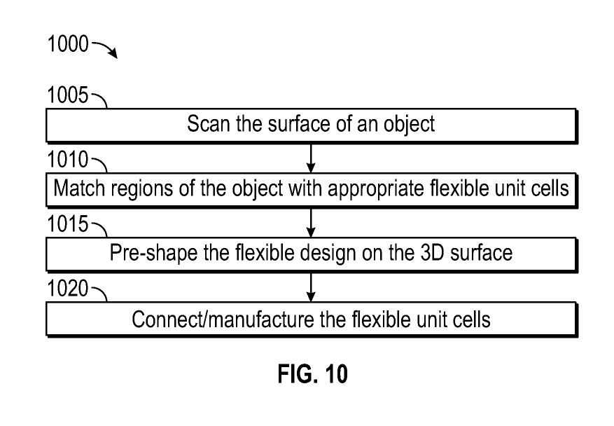

FIG. 10 is a process 1000 for manufacturing a flexible design according to one or more embodiments described herein. At a step 1005, a scan is performed of the surface on which the flexible design is to fit. For example, a scan may be performed of a body part or some other object on which the flexible design is to be applied. The scan may be performed using scanning/imaging hardware and/or software (e.g., 3D scanning/imaging hardware/software) to create a digital representation of the object including at least the surface of the object. Alternatively, the digital representation of the object may be obtained by other means.

At a step 1010, regions of the object may be matched with appropriate flexible unit cells for the region of the flexible design associated with that region of the object. For example, the shape, size, and/or type of flexible connection portion used for the flexible unit cells in a given region of the flexible design may be selected based on the desired degree and direction of flexibility required in that region. For example, a region of the object with a relatively un-curved flat surface and/or that does not move on the object may be selected to have larger flexible unit cells for the region of the flexible design associated with that region of the object. Further, a region of the object with a more curved surface and/or that moves on the object may be selected to have smaller flexible unit cells for the region of the flexible design associated with that region of the object. The selection of the appropriate flexible unit cells for the given region of a flexible design may be, in some embodiments, performed automatically such as based on a determined curvature of the object in that region, or an interpreted amount of movement assigned with that region. The selection, accordingly may be made by way of hardware and/or software developed for such selection. Alternatively or additionally, the selection of appropriate flexible unit cells may be made manually, such as through manual selection by a user using specialized hardware and/or software.

At a step 1015, the flexible design may be “pre-shaped” onto the object. For example, a digital representation of the flexible design is contoured to fit to the surface of the object, including any curves and flat surfaces.

At a step 1020, the flexible design itself is manufactured. For example, the digital representation of the flexible design may be used to generate using additive manufacturing techniques a physical flexible design that has the selected flexible unit cells and is shaped to the surface of the object. In another example, individual flexible unit cells may be connected to each other to make a flexible design that is shaped to the surface of the object.

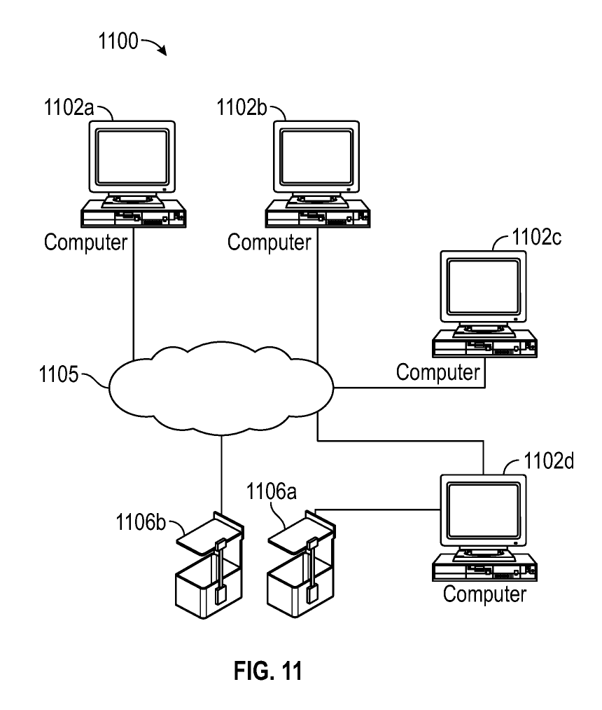

FIG. 11 illustrates one example of a system 1100 for designing and manufacturing an object by additive manufacturing, including, for example, a flexible unit cell and/or a flexible design as described herein. The system 1100 may be configured to support the techniques described herein.

In some embodiments, the system 1100 may include one or more computers 1102a-1102d. The computers 1102a-1102d may take various forms such as, for example, any workstation, server, or other computing device capable of processing information. The computers 1102a-1102d may be connected by a computer network 1105. The computer network 1105 may be, for example, the Internet, a local area network, a wide area network, or some other type of network capable of digital communications between electronic devices. Additionally, the computers 1102a-1102d may communicate over the computer network 1105 via any suitable communications technology or protocol. For example, the computers 1102a-1102d may share data by transmitting and receiving information such as software, digital representations of 3D objections, commands and/or instructions to operate an additive manufacturing device, and the like. Further, the computers 1102a-1102d may be configured to design and/or direct manufacture of any of the embodiments of the flexible unit cell and/or a flexible design described herein. For example, the computers 1102a-1102d may have specialized hardware and/or software designed to design and/or direct manufacture of any such embodiments.

The system 1100 further may include one or more additive manufacturing devices 1106a and 1106b. These additive manufacturing devices may comprise 3D printers or some other manufacturing device as known in the art. In the example shown in FIG. 11, the additive manufacturing device 1106a is directly connected to the computer 1102d. The additive manufacturing device 1106a is also connected to computers 1102a-1102c via the network 1105, which further connects computers 1102a-1102d. Additive manufacturing device 1106b is also connected to the computers 1102a-1102d via the network 1105. A skilled artisan will readily appreciate that an additive manufacturing device such as devices 1106a and 1106b may be directly connected to a computer, connected to a computer, and/or connected to a computer via another computer.

Although a specific computer and network configuration is described in FIG. 11, a skilled artisan will also appreciate that the additive manufacturing techniques described herein may be implemented using a single computer configuration which controls and/or assists the additive manufacturing device 1106, without the need for a computer network.

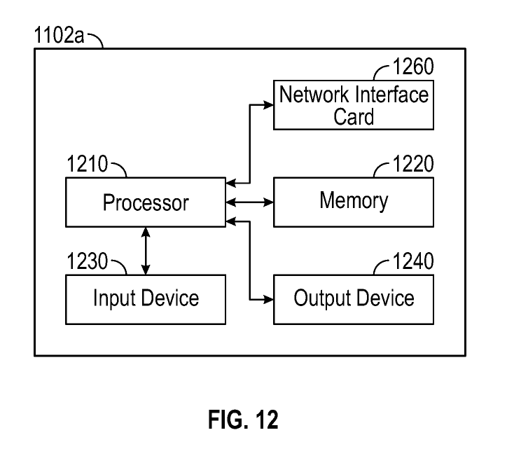

FIG. 12 illustrates a more detailed view of computer 1102a illustrated in FIG. 11. The computer 1102a includes a processor 1210. The processor 1210 is in data communication with various computer components. These components may include a memory 1220, an input device 1230, and an output device 1240. In certain embodiments, the processor may also communicate with a network interface card 1260. Although described separately, it is to be appreciated that functional blocks described with respect to the computer 1102a need not be separate structural elements. For example, the processor 1210 and network interface card 1260 may be embodied in a single chip or board.

The processor 1210 may be a general purpose processor, a digital signal processor (DSP), an application specific integrated circuit (ASIC), a field programmable gate array (FPGA) or other programmable logic device, a discrete gate or transistor logic, discrete hardware components, or any suitable combination thereof designed to perform the functions described herein. A processor may also be implemented as a combination of computing devices, e.g., a combination of a DSP and a microprocessor, a plurality of microprocessors, one or more microprocessors in conjunction with a DSP core, or any other such configuration.

The processor 1210 may be coupled, via one or more data buses, to read information from or write information to memory 1220. The processor may additionally, or in the alternative, contain memory, such as processor registers. The memory 1220 may include processor cache, including a multi-level hierarchical cache in which different levels have different capacities and access speeds. The memory 1220 may further include random access memory (RAM), other volatile storage devices, or non-volatile storage devices. The storage can include hard drives, optical discs, such as compact discs (CDs) or digital video discs (DVDs), flash memory, floppy discs, magnetic tape, Zip drives, USB drives, and others as are known in the art.

The processor 1210 may also be coupled to an input device 1230 and an output device 1240 for, respectively, receiving input from and providing output to a user of the computer 1102a. Suitable input devices include, but are not limited to, a keyboard, a rollerball, buttons, keys, switches, a pointing device, a mouse, a joystick, a remote control, an infrared detector, a voice recognition system, a bar code reader, a scanner, a video camera (possibly coupled with video processing software to, e.g., detect hand gestures or facial gestures), a motion detector, a microphone (possibly coupled to audio processing software to, e.g., detect voice commands), or other device capable of transmitting information from a user to a computer. The input device may also take the form of a touch-screen associated with the display, in which case a user responds to prompts on the display by touching the screen. The user may enter textual information through the input device such as the keyboard or the touch-screen. Suitable output devices include, but are not limited to, visual output devices, including displays and printers, audio output devices, including speakers, headphones, earphones, and alarms, additive manufacturing devices, and haptic output devices.

The processor 1210 further may be coupled to a network interface card 1260. The network interface card 1260 prepares data generated by the processor 1210 for transmission via a network according to one or more data transmission protocols. The network interface card 1260 may also be configured to decode data received via the network. In some embodiments, the network interface card 1260 may include a transmitter, receiver, or both. Depending on the specific embodiment, the transmitter and receiver can be a single integrated component, or they may be two separate components. The network interface card 1260, may be embodied as a general purpose processor, a DSP, an ASIC, a FPGA, or other programmable logic device, discrete gate or transistor logic, discrete hardware components, or any suitable combination thereof designed to perform the functions and/or processes described herein.

The processor 1210 and/or memory 1220 may be configured to design and/or manufacture any of the embodiments of the flexible unit cell and/or a flexible design described herein. For example, the process for manufacture of the flexible unit cell and/or a flexible design, such as described with respect to FIG. 10, may be designed to run as specialized hardware in the form of the processor 1210. Additionally or alternatively, the process may be programmed and stored in software on the memory 1220 and executed by the processor 1210 so that the computer 1102a performs any of the processes described herein. In some embodiments, embodiments of the process for manufacture of a flexible unit cell and/or a flexible design described herein are stored in memory and the memory comprises a non-transitory computer readable medium (e.g., RAM, hard drive, flash drive, etc.).

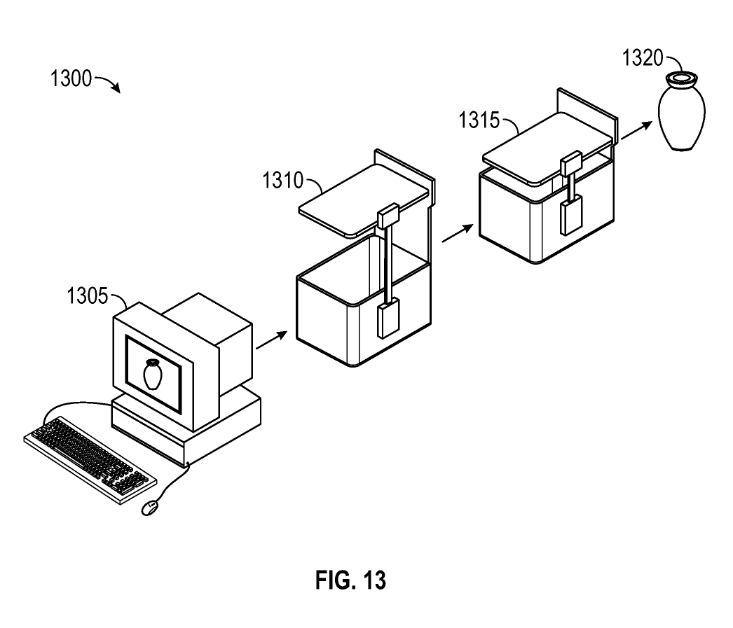

FIG. 13 illustrates a general process 1300 for manufacturing an object, such as a flexible unit cell and/or a flexible design described herein, using an additive manufacturing apparatus, such as 1106a or 1106b in FIG. 11.

The process begins at step 1305, where a digital representation of the device to be manufactured is designed using a computer, such as the computer 1102a in FIG. 11. In some embodiments, a 2D representation of the device may be used to create a 3D model of the device. Alternatively, 3D data may be input to the computer 502a for aiding in designing the digital representation of the 3D device. The process continues to step 1310, where information is sent from the computer 1102a to an additive manufacturing device, such as additive manufacturing devices 1106a and 1106b. Next, at step 1315, the additive manufacturing device begins manufacturing the 3-D device by performing an additive manufacturing process using suitable materials, as described above. Using the appropriate materials, the additive manufacturing device then completes the process at step 1320, where the 3D object is completed.

Various specific additive manufacturing techniques may be used to produce objects using a method like that shown in FIG. 13. As explained above, these techniques include SLA, SLS, and SLM, among others.

The invention disclosed herein may be implemented as a method, apparatus, or article of manufacture using standard programming or engineering techniques to produce software, firmware, hardware, or any combination thereof. The term “article of manufacture” as used herein refers to code or logic implemented in hardware or non-transitory computer readable media such as optical storage devices, and volatile or non-volatile memory devices or transitory computer readable media such as signals, carrier waves, etc. Such hardware may include, but is not limited to, FPGAs, ASICs, complex programmable logic devices (CPLDs), programmable logic arrays (PLAs), microprocessors, or other similar processing devices.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A flexible unit cell having a geometric shape, comprising:
a rigid portion comprising:
a top surface and a bottom surface each of which has a same substantially geometric shape as the flexible unit cell,
a central portion connecting the top surface and bottom surface, and
a plurality of side portions; and
a flexible connection portion configured to connect with at least one additional flexible unit cell so as to allow relative movement between the flexible unit cell and the at least one additional flexible unit cell, wherein the flexible connection portion and the central portion comprise a single continuous part.

2. The flexible unit cell of claim 1, wherein the rigid portion forms an exterior portion of the flexible unit cell, and wherein the flexible connection portion is positioned at an interior portion of the flexible unit cell.

3. The flexible unit cell of claim 1, wherein the flexible connection portion comprises a leaf spring.

4. The flexible unit cell of claim 3, wherein the leaf spring is configured to limit relative movement between the flexible unit cell and the at least one additional flexible unit cell in one direction to a greater degree than in a different direction.

5. The flexible unit cell of claim 1, wherein the flexible unit cell and the at least one additional flexible unit cell have at least one of a different shape, size, or type of flexible connection portion.

6. The flexible unit cell of claim 1, wherein at least one of the plurality of side portions comprises an opening, and wherein the flexible connection portion is positioned within the opening and configured to move within the opening when connected to the at least one additional flexible unit cell.

7. The flexible unit cell of claim 6, wherein the rigid portion surrounds all sides of the opening.

8. (canceled)

9. The flexible unit cell of claim 1, wherein the flexible unit cell is manufactured using additive manufacturing techniques.

10. A method for designing a flexible design comprising a plurality of flexible unit cells, the method comprising:
obtaining a digital representation of a surface of an object utilizing at least one of imaging hardware or software;
selecting a flexible unit cell for the flexible design based on at least one of a determined curvature or an interpreted amount of movement of regions of the object, wherein the flexible unit cell comprises:
a rigid portion comprising:
a top surface and a bottom surface each of which has a same substantially geometric shape as the flexible unit cell,
a central portion connecting the top surface and bottom surface, and
a plurality of side portions; and
a flexible connection portion configured to connect with the at least one additional flexible unit cell so as to allow relative movement between the flexible unit cell and the at least one additional flexible unit cell, wherein the flexible connection portion and the central portion comprise a single continuous part; and
pre-shaping the flexible design to the surface of the object, wherein pre-shaping the flexible design comprises contouring a digital representation of the flexible design to fit the surface of the object.

11. (canceled)

12. The method of claim 10, further comprising manufacturing the flexible design as a single continuous part.

13. The method of claim 11, wherein the manufacturing comprises manufacturing the flexible design utilizing additive manufacturing techniques.

14. The method of claim 10, wherein the top surface, bottom surface, and plurality of side portions of the rigid portion define at least one opening in the rigid portion.

15. The method of claim 14, wherein the at least one opening comprises a plurality of openings, wherein each of a plurality of sides of the rigid portion includes one of the plurality of openings, further comprising a plurality of flexible connection portions, wherein one of the plurality of flexible connection portions is positioned in each one of the plurality of openings, and wherein each of the plurality of flexible connection portions is configured to connect with a different flexible unit cell.

16. The method of claim 14, wherein the flexible connection portion is positioned within the at least one opening and configured to move within the opening when connected to the at least one additional flexible unit cell.

17. The flexible unit cell of claim 1, wherein the top surface, bottom surface, and plurality of side portions of the rigid portion define at least one opening in the rigid portion.

18. The flexible unit cell of claim 17, wherein the at least one opening comprises a plurality of openings, wherein each of a plurality of sides of the rigid portion includes one of the plurality of openings, further comprising a plurality of flexible connection portions, wherein one of the plurality of flexible connection portions is positioned in each one of the plurality of openings, and wherein each of the plurality of flexible connection portions is configured to connect with a different flexible unit cell.

19. The flexible unit cell of claim 1, wherein the rigid portion is configured to interact with a second rigid portion of at least one additional flexible unit cell so as to limit relative movement between the flexible unit cell and the at least one additional flexible unit cell through contact between the rigid portion and the second rigid portion.

20. A flexible design comprising:
a plurality of interconnected unit cells, each of the plurality of interconnected unit cells comprising:
a rigid portion comprising:
a top surface and a bottom surface each of which has a same substantially geometric shape as the flexible unit cell,
a central portion connecting the top surface and bottom surface, and
a plurality of side portions; and
a plurality of flexible connection portions, wherein each of the plurality of flexible connection portions is configured to connect with another one of the plurality of interconnected unit cells so as to allow relative movement between each of the plurality of interconnected unit cells, and wherein the plurality of flexible connection portions and the central portion comprise a single continuous part.

21. The flexible design of claim 20, wherein the top surface, bottom surface, and plurality of side portions of the rigid portion define a plurality of openings in the rigid portion.

22. The flexible design of claim 21, wherein each of the plurality of flexible connection portions is positioned within one of the plurality of openings.

23. The flexible design of claim 22, wherein each of the plurality of flexible connection portions is configured to move within a respective one of the plurality of openings.
